(19) United States
(12) Patent Application Publication
(10) Pub. No.: US 2025/0193785 A1
(43) Pub. Date: Jun. 12, 2025

(54) METHOD TO TRIGGER CONNECTIVITY TO AN OVERLAY NETWORK VIA AN UNDERLAY NETWORK

(71) Applicant: LENOVO (SINGAPORE) PTE LIMITED, Singapore (SG)

(72) Inventors: Apostolis SALKINTZIS, Athens (GR); Genadi VELEV, Darmstadt (DE); Dimitrios KARAMPATSIS, Middlesex (GB)

(21) Appl. No.: 18/845,672

(22) PCT Filed: Apr. 28, 2022
(86) PCT No.: PCT/EP2022/061426

§ 371 Date: Sep. 10, 2024

(30) Foreign Application Priority Data
Mar. 11, 2022 (GR) 20220100229

(51) Int. Cl. H04W 48/18; H04L 47/20; H04W 76/15

(52) U.S. Cl. CPC H04W 48/18; H04L 47/20; H04W 76/15

(57) ABSTRACT

A user equipment, UE, apparatus comprising: a transceiver arranged to communicate with a first mobile network; and a processor arranged to: receive a UE Route Selection Policy, URSP, rule from the first mobile network (e.g. an underlay network), wherein the URSP rule indicates traffic that is to be sent to a second mobile network (e.g. an overlay network) via the first mobile network; detect traffic that matches the URSP rule; establish, using the transceiver, a first data connection in the first mobile network based on the URSP rule; establish, using the transceiver, connectivity to the second mobile network via the first data connection; and send, using the transceiver, selected traffic to the second mobile network via the established connectivity to the second mobile network, the selected traffic being the traffic that matches the URSP rule.

### FIELD OF THE INVENTION

The present invention relates to triggering connectivity of a user equipment apparatus to an overlay network via an underlay network.

### BACKGROUND

A user equipment apparatus may access its home Public Land Mobile Network (PLMN), thereby to access services accessible via said PLAIN. Such services accessible by a user equipment apparatus may include, for example, those accessible via the Internet, such as video streaming services, video conferencing services, game services, chat services, email services, online shopping services, etc.

However, certain services may be inaccessible to a user equipment apparatus via a given PLMN. Should a user wish to access a service inaccessible to the PLAIN to which the user equipment apparatus is currently connected, it may need to register the user equipment apparatus with networks, e.g. hosting networks, via which the desired service is accessible.

### SUMMARY OF THE INVENTION

In an aspect, there is provided a user equipment, UE, apparatus comprising a transceiver arranged to communicate with a first mobile network, and a processor. The processor is arranged to: receive a UE Route Selection Policy, URSP, rule from the first mobile network, wherein the URSP rule indicates traffic that is to be sent to a second mobile network via the first mobile network; detect traffic that matches the URSP rule; establish, using the transceiver, a first data connection in the first mobile network based on the URSP rule; establish, using the transceiver, connectivity to the second mobile network via the first data connection; and send, using the transceiver, selected traffic to the second mobile network via the established connectivity to the second mobile network, the selected traffic being the traffic that matches the URSP rule. Establishing the connectivity to the second mobile network via the first data connection is preferably triggered based on the URSP rule, e.g. based on an overlay network component in the URSP, which is described herein.

To a further aspect, there is provided a method for performance by a user equipment, UE, apparatus. The method comprises: receiving a UE Route Selection Policy, URSP, rule from a first mobile network, wherein the URSP rule indicates traffic that is to be sent to a second mobile network via the first mobile network; detecting traffic that matches the URSP rule; establishing a first data connection in the first mobile network based on the URSP rule; establishing connectivity to the second mobile network via the first data connection; and sending selected traffic to the second mobile network via the established connectivity to the second mobile network, the selected traffic being the traffic that matches the URSP rule. Establishing the connectivity to the second mobile network via the first data connection is preferably triggered based on the URSP rule, e.g. based on an overlay network component in the URSP, which is described herein.

In a further aspect, there is provided one or more network nodes of a first mobile network used by a user equipment, UE. The one or more network nodes are arranged to: send a UE Route Selection Policy, URSP, to the UE, wherein the URSP rule indicates traffic that is to be sent to a second mobile network via a first data connection in the first mobile network; establish the first data connection with the UE; and convey traffic received from the UE to the second mobile network via the established first data connection, the traffic being that indicated by the URSP rule.

In a further aspect, them is provided a method performed by one or more network nodes of a first mobile network used by a user equipment, UE. The method comprises: sending a UE Route Selection Policy, URSP, to the UE, wherein the URSP rule indicates traffic that is to be sent to a second mobile network via a first data connection in the first mobile network; establishing the first data connection with the UE; and conveying traffic received from the UE to the second mobile network via the established first data connection, the traffic being that indicated by the URSP rule.

In an aspect, there is provided a user equipment, UE, apparatus comprising: a transceiver arranged to communicate with a first mobile network, and with a second mobile network via the first mobile network; and a processor arranged to: determine, using a first Route Selection Policy, URSP, rule received from the first mobile network, traffic to be sent to the second mobile network; responsive to determining the traffic to be sent to the second mobile network using the first URSP rule, determine, using a second URSP rule received from the second mobile network, a data connection in the second mobile network for the determined traffic; and send, using the transceiver, traffic matching the first or second URSP rule to the second mobile network via the data connection.

In a further aspect, there is provided a method for performance by a user equipment, UE, apparatus. The method comprises: determining, using a first Route Selection Policy, URSP, rule received from a first mobile network, traffic to be sent to a second mobile network; responsive to determining the traffic to be sent to the second mobile network using the first URSP rule, determining, using a second URSP rule received from the second mobile network, a data connection in the second mobile network for the determined traffic; and sending traffic marching the first and/or second URSP rule to the second mobile network, via the data connection.

In a further aspect, there is provided one or more network nodes of a first mobile network used by a user equipment, UE. The one or more network nodes are arranged to: send a first UE Route Selection Policy, URSP, to the UE, wherein the first URSP rule indicates traffic that is to be sent to a second mobile network; convey a second URSP rule from the second mobile network to the UE; and convey traffic received from the UE to the second mobile network, the traffic being that indicated by the second URSP rule.

In a further aspect, there is provided a method performed by one or more network nodes of an first mobile network of a user equipment, UE. The method comprises: sending a first UE Route Selection Policy, URSP, to the UE, wherein the first URSP rule indicates traffic that is to be sent to a second mobile network connected via the first mobile network; conveying a second URSP rule from the second mobile network to the UE; and conveying traffic received from the UE to the second mobile network, the traffic being that indicated by the first and/or second URSP rule.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

FIG. 1 is a schematic illustration (not to scale) of a network architecture comprising a user equipment apparatus, a home network, and a plurality of hosting networks.

FIG. 2 is a schematic illustration (not to scale) of a user equipment apparatus that may be used for implementing the methods described herein.

FIG. 3 is a schematic illustration (not to scale) of a network node that may be used for implementing the methods described herein.

FIG. 4 is a schematic illustration (not to scale) of a connectivity model.

FIG. 5 is a schematic illustration (not to scale) of a network architecture in which the user equipment apparatus may access an overlay network via an underlay network.

FIG. 6 is a schematic illustration of a first user equipment apparatus Route Selection Policy rule.

FIG. 7 is a schematic illustration of the first user equipment apparatus Route Selection Policy rule and a second user equipment apparatus Route Selection Policy rule.

FIG. 8 is a schematic illustration (nor to scale) of a network architecture in which the user equipment apparatus may access the overlay network via the underlay network.

FIG. 9 is a process flow chart showing certain steps of a method which may be performed by the user equipment apparatus.

FIG. 10 is a process flow chart showing certain steps of a method performed by one or more network nodes of the underlay network used by the user equipment apparatus.

FIG. 11 is a process flow chart showing certain steps of a further method which may be performed by the user equipment apparatus.

FIG. 12 is a process flow chart showing certain steps of a further method performed by one or more network nodes of the underlay network used by the user equipment apparatus.

FIG. 13 is a process flow chart showing certain steps of a yet further method performed by one or more network nodes of the underlay network used by the user equipment apparatus.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatuses may be implemented as a hardware circuit comprising custom very-large-scale integration (“VLSI”) circuits or gate arrays, off-the-shelf semiconductors such as logic chips, transistors, or other discrete components. The disclosed methods and apparatuses may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, methods and apparatuses may rake the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM”) or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C, includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In die following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are nor shown or described in detail to avoid obscuring aspects of the disclosure.

Aspects of the disclosed methods and apparatuses are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus no produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparats, or other devices to cause a series of operational steps to be performed on the computer, other programmable apparatus, or other devices to produce a computer implemented process such that the code which execute on the computer or other programmable apparatus provide processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding figures. Like numbers refer to like elements in all figures.

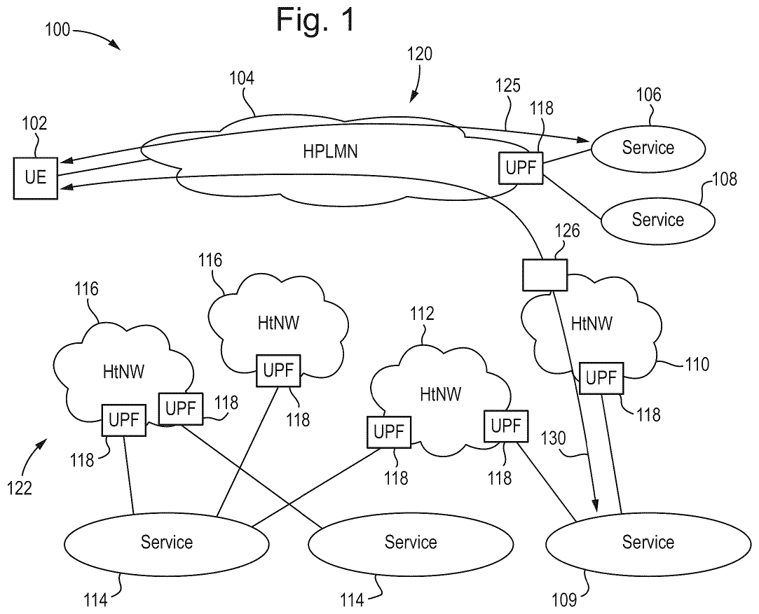

FIG. 1 is a schematic illustration (not to scale) of a network architecture 1I comprising a user equipment apparats (UE) 102, a home network 104, and a plurality of hosting networks (HtNWs).

In this and other embodiments, the home network 104 is a Home Private Land Mobile Network (HPLMN) 104.

As can be seen in FIG. 1, when the UE 102 accesses its home PLMN, i.e. the HPLMN 104, it is able to access all services accessible via this HPLMN 104, such as a first service 106 and a second service 108. For example, when the HPLMN 104 provides connectivity to the Internet, the UE 102 can access one or both of the first service 106 and the second service 108 accessible via the Internet, such as video streaming services, video conferencing services, game services, chat services, email services, online shopping services, etc.

However, some services may not be accessible to the UE 102 via the HPLMN 104. In the example deployment shown in FIG. 1, a third service 109 inaccessible in the YPLMN 104 is accessible via two HtNWs, namely, a first HtNW 110 and a second HtNW 112. Therefore, should a user of the UE 102 desire to access the third service 109 the UE 102 may be aware that access to the third service 109 is provided by a HtNW, e.g. the first and second HtNWs 110, 112, and may be capable of registering with said HtNW(s). Further services 114 may be accessible by respective further HtNWs 116. In this embodiment, each of the HtNWs may be a PLMN or a Stand-alone Non-Public Network (SNPN), in either case having a 5G core network.

Each of the HtNWs and the HPLMN 104 may access its respective service(s) via a respective User Plane Function (UPF) 118.

Based on the existing 3GPP specifications (see TS 23.501, annex D.3), the UE 102 may register with one or more of the HtNWs (e.g. the first HtNW 110 or second HtNW 112) via a PLMN (e.g. the HPLMN 104), and may be simultaneously registered with both of the HtNW and the PLMN, thereby to utilize services accessible via each network. Using the 3GPP terminology, a HtNW (e.g. the first and/or second HtNW 110, 112) is called an “overlay” network and the PLMN that provides connectivity to the overlay network, e.g. the HPLMN 104, is called an “underlay” network.

UE 102 connects to the overlay network 122 via the underlay network, 120 as shown in FIG. 1. In this embodiment, the underlay network 120 is the HPLMN 104 and the overlay network 122 is a network of one or more of the HtNWs, e.g. the first HtNW 111.

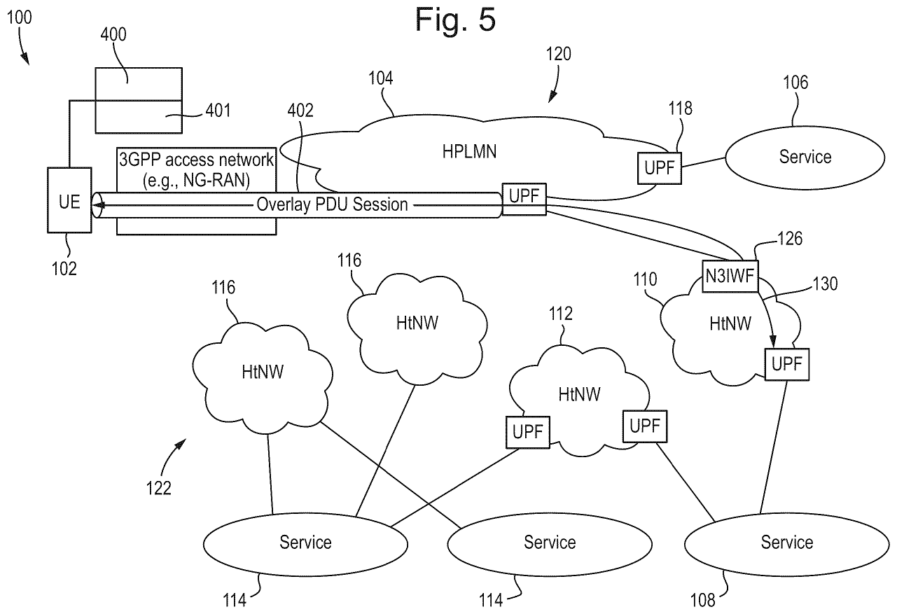

As indicated in FIG. 1 with a double-headed arrow and the reference numeral 125, the UE 102 establishes a PDU session in the underlay network 120 to obtain IP connectivity. Then, the UE 102 discovers a Non-3GPP Interworking Function (N3IWF) 126 in the overlay network 122 (e.g., by using DNS procedures) and, finally, as indicated in FIG. 1 with a double-headed arrow and the reference numeral 130, it registers with the overlay network 122 via the discovered N3IWF 126. As is described in more derail below with reference to FIGS. 5-8, in this manner, all traffic between the UE 102 and the overlay network 122 may be exchanged via the PDU session (e.g. the underlay PDU session 125) in the underlay network 120.

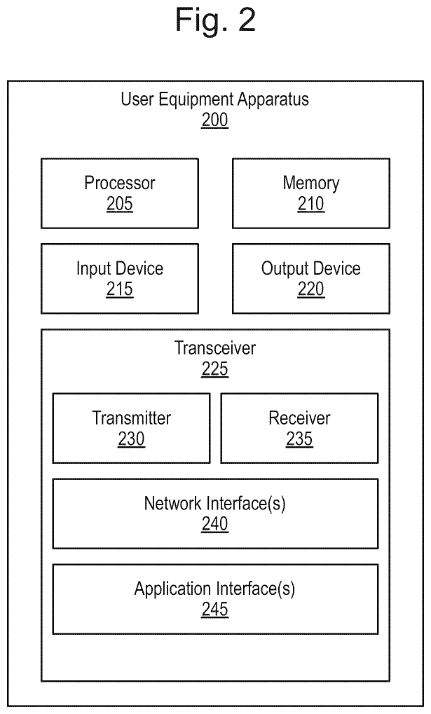

FIG. 2 depicts a user equipment apparatus 200 that may be used for implementing the methods described herein. The user equipment apparatus 200 is in accordance with the UE 110 described above, and is hence hereinafter referred to as the UE 200. The UE 200 is used to implement one or more of the solutions described below. The user equipment apparatus 200 includes a processor 205, a memory 210, an input device 215, an output device 220, and a transceiver 225.

The input device 215 and the output device 220 may be combined into a single device, such as a touchscreen. In some implementations, the UE 200 does not include any input device 215 and/or output device 220. The UE 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the UE 200 to implement the UE behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 2101 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implementing a traffic category field. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 224, may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting example, the output device 220 may include a wearable display separate from, but communicatively coupled to, the rest of the UE 200, such as a smart watch, smart glasses, a heads up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink (UL) communication signals to a base unit of a wireless communications network. Similarly, the one or more receivers 235 may be used to receive downlink (DL) communication signals from the base unit. Although only one transmitter 230 and one receiver 235 are illustrated, the UE 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

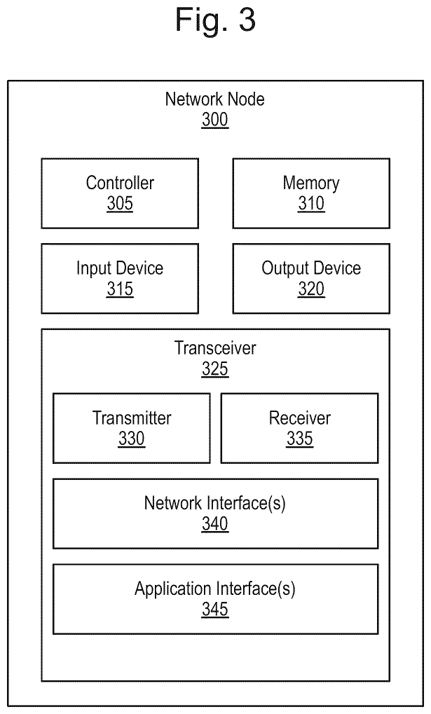

FIG. 3 depicts a network node 300 that may be used for implementing the methods described herein. The network node 300 may be one implementation of an entity in a wireless communications network, e.g., the HPLMN 104 and/or the HtNWs, i.e. the underlay network 120 and the overlay network 122, and/or, unless stated otherwise, any of the other networks described herein. The network node 300 may be, for example, the UE 200 described above. The network node 300 includes a controller 305, a memory 310, an input device 315, an output device 320, and a transceiver 325.

The input device 315 and the output device 320 may be combined into a single device, such as a touchscreen. In some implementations, the network node 300 does nor include any input device 315 and/or output device 320. The network node 300 may include one or more of: the controller 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The controller 305 may include any known controller capable of executing computer-readable instructions and/or capable of performing logical operations. For example, the controller 305 may be a microcontroller, a microprocessor, a CPU, a CPU, an auxiliary processing unit, a FPGA, or similar programmable controller. The controller 305 may execute instructions stored in the memory 310 to perform the methods and routines described herein. The controller 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 3111 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described below. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LC-D display, an LED display, an OLED display, a projector, or similar display device capable of outputting images, text, or the like to a user. As another, non-limiting, example, die output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

Although the 3GPP specifications define how the UE 200 can connect to the overlay network 122 via the underlay network 120, they omit two important aspects.

The first issue relates to how the underlay network 120 triggers the UE 200 to establish connectivity to the overlay network 122 and to send selected traffic to this overlay network 122.

In particular, how the HPLMN 104 can indicate to the UE 200 that certain services or applications are accessible via the overlay network 122, and trigger the UE 200 to connect to the overlay network 122 when it wants to access these services or applications, is nor currently specified in the art.

The 3GPP specifications implicitly assume that the UE 20) decides to connect to the overlay network 122 using its own logic (which is not defined in the specifications). In a typical implementation, for example, the UE 200 may decide to connect to the overlay network 122 when the UE 200 has a subscription with the overlay network 122 and the UE 200 is pre-configured to know which services are accessible via this overlay network 122.

In other cases, however, the UE 210 is not expected to decide by itself to connect to the overlay network 122. In such cases, the UE 200 tends to need some information from the HPLMN 104 to trigger the UE (i.e. the overlay network) to connect to the overlay network 122 and to obtain access to some services via the overlay network 122. Methods and apparatuses for achieving this are described herein. Notably, although the UE 200 may not have a subscription with the overlay network 122, the UE 200 could still connect to the overlay network 122 using its HPLMN credentials, as currently defined in 3GPP specifications.

The second issue is that of how, after the UE 20W connects simultaneously with the underlay and the overlay networks 122, 120, the UE 200 applies one or more UE Route Selection Policy (URSP) rules, which URSP rules may be provided to the UE 200 by either or both networks.

If the UE 200 receives the one or more URSP rules from both networks, i.e. both of the underlay network 120 and the overlay network 122, it is preferable that the UE 200 knows how these rules should be applied. Note that a URSP rule(s) from the overlay network 122 and a URSP rule(s) from the underlay network 120 may be in conflict, i.e., give conflicting instructions to the UT 200.

Described herein are embodiments which present solutions that tend to address these problems.

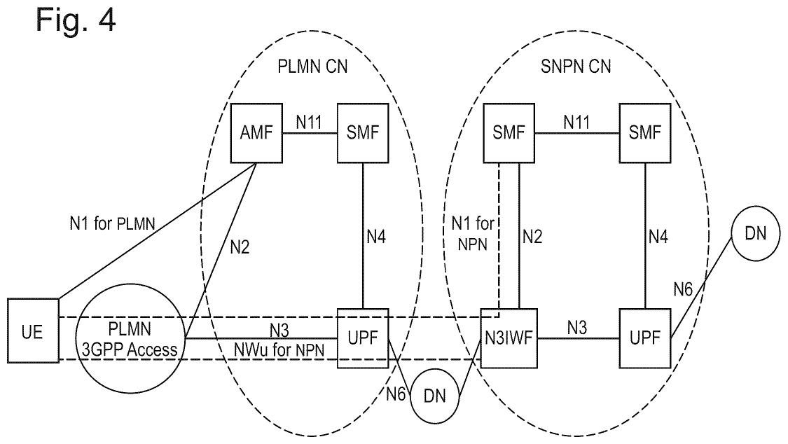

The “support for access to PLMN services via Stand-alone Non-Public Network and access to Stand-alone Non-Public Network services via PLMN” is specified in TS 23.501, Annex D. It is known from this annex that UE connectivity to an overlay network (e.g. a SNPN Core Network) can be obtained via an underlay network (e.g. a PLMN Core Network) and through an N3IWF in the overlay network. This connectivity model is applied in the present disclosure too, and is illustrated schematically in FIG. 4.

As mentioned above, although the 3GPP specifications define how the UE 200 can connect to the overlay network 122 via the underlay network 120, they fail to define how the underlay network 120 can trigger the UE 200 to establish connectivity to an overlay network 122 and to send selected traffic to the overlay network 122. The 3GPP specifications also define URSP rules, which can be provisioned in the UE 200 and can trigger the UE 200 to establish various PDU sessions in the underlay network 120. However, these URSP rules cannot trigger the UE 200 to establish connectivity with the overlay network 122 via the underlay network 120, i.e., while the UE 200 remains connected to the underlay network 121. Moreover, when the UE 200 connects to the underlay network 120 and the overlay network 122 and receives a URSP rule from both networks (i.e. each network), the 3GPP specifications do not specify the manner in which these URSP rules are applied by the UE 200. The embodiments described herein aim to fill these gaps.

FIG. 5 is a schematic illustration of the network architecture 100 in which the UE may access the overlay network 122 via the underlay network 120.

In this embodiment, the UE 200 is connected with the underlay network 120, i.e., with the HPLMN 14.

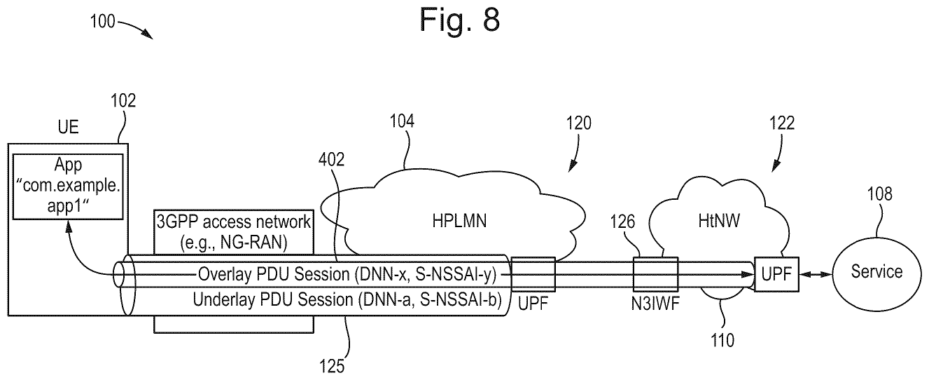

In this embodiment, the UE 200 receives a first URSP rule 400 from the underlay network 120 that indicates to UE 200 what traffic should be sent to the overlay network 122 via the underlay network 120. As is explained in further detail below, with reference to FIGS. 7 and 8, the UE 200 may also receive a second URSP rule 401 to be used to determine a route, namely the overlay network 122, for the traffic.

The UE 200 receives the first URSP rule 4001, which indicates that the traffic of an application with a first identifier (ID) should be sent to the first HtNW 110. i.e. the overlay network 122, via a PDU session (e.g. the underlay PDU session 125) in the underlay network 120 that should be established over 3GPP access using certain parameters, e.g., a DNN and/or a S-NSSAI.

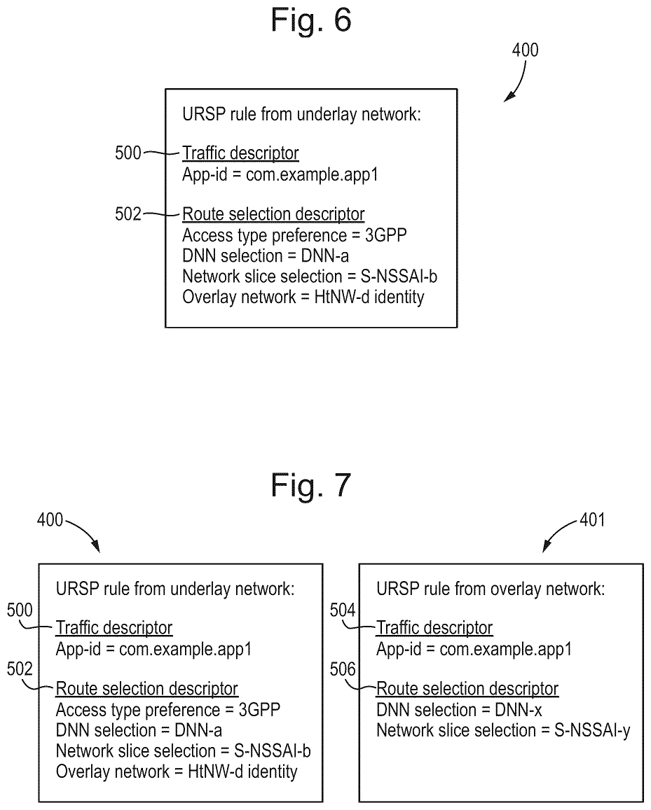

FIG. 6 depicts the first URSP rule 400.

The first URSP rule 400 comprises a first Traffic Descriptor (TD) 500 and a first Route Selection Descriptor (RSD) 502.

The first TD 500 comprises the first YD. Specifically, in this embodiment, the first TD 500 comprises the first ID of the application, which is an application ID, namely “com.example.app1”.

A novel component of the first RSD 502, i.e., an “overlay network” component, is a part of the first URSP rule 400 which indicates to the UE 200 that (a) the UE 200 should connect to an overlay network (e.g. the overlay network 122) via a PDU session in the underlay network (e.g. the underlay PDU session 125) and (b) the UE 200 should send to this overlay network selected traffic, i.e., traffic of the application having the first ID.

In some embodiments, the first RSD 502 may contain only the “overlay network” component (without the other three components shown in the first URSP rule 400 of FIG. 6), in which case, the traffic of the application (having the first ID “com.example.app1”) should be sent to the overlay network 122 via any PDU session in the underlay network, 120. In this case, the underlay network 120 does not require the UE 200 to use a specific PDU session in the underlay network 120 for sending traffic to the overlay network 122.

In this embodiment, the UE. 200 detects traffic that matches the received first URSP rule 400, i.e., it detects traffic sent by the application having the first ID “com.example.app1”. This traffic may be sent by the application, e.g., to establish a connection with a cloud server and receive fresh information from the server or to send updated information to the server.

In response to detecting traffic that matches the received first URSP rule 400, in this embodiment, the UE 200 establishes a PDU session in the underlay network 120, e.g. the underlay PDU session 125, based on parameters of the first RSD 502 in the first URSP rule 400, if such a PDU session is not already established. Subsequently, the UE 200 establishes connectivity to an overlay network 122 via this PDU session, and sends the matched traffic to the overlay network 122 via this PDU session.

In this embodiment, to establish connectivity to the overlay network 122, the UE 200) (a) discovers the N3IWF 126 in the overlay network 122 (using known procedures, e.g., based on the Domain Name System) and (b) initiates a registration procedure with the overlay network 122 via the discovered N3IWF 126 (again, using known procedures). The registration procedure with the overlay network 122 comprises an authentication procedure, for which the UL. 200 may present authentication credentials. In case the UE 200 has a subscription with the overlay network 122, the UE 200 presents the stored authentication credentials for the overlay network 122. In case the UE 200 has no subscription with the overlay network 122, the UE 200 presents die stored authentication credential for the underlay network 120, which are applied to authenticate the UE 200. In this case, the underlay network 120 serves as a “credentials holder” (CH) and the way in which the UE 200 may be authenticated is specified in TS 23.501, clause 5.30.2.9, “SNPN connectivity for UEs with credentials owned by Credentials Holder”.

The above embodiment addresses the first aforementioned issue, i.e., how an underlay network may trigger a UE to establish connectivity to an overlay network and to send selected traffic to the overlay network.

After the UE 200 establishes connectivity, to the overlay network 122, the UE 200 may also receive a further one or more URSP rules (e.g. the second URSP rule 401) from the overlay network 122, especially when the UE 200 happens to have a subscription with the overlay network 122. In an embodiment, the UE 200 receives one or more URSP rules from the underlay network 120 (e.g. the first URSP rule 400) and a further one or more URSP rules from the overlay network 122 (e.g. the second URSP rule 401). Since there may be a lack of, or no, coordination between these rules, they may provide conflicting policy rules to the UE 200. Therefore, the UE 200 rends to know how, i.e. be configured, to apply the one or more URSP rules and the further one or more URSP rules to avoid conflicts and to meet the route selection requirements of both networks. This is accomplished in the embodiment described below, with reference to FIG. 7.

FIG. 7 depicts the first URSP rule 40W and the second URSP rule 401. The first URSP rule 400 is a URSP rule for matching traffic in the underlay network 120, i.e. is an underlay URSP rule 400. The second URSP rule 401 is a URSP rule for marching traffic in the overlay network 122, i.e. is an overlay URSP rule 401.

The overlay URSP rule 401 comprises a second TD 504 and a second RSD 504. In this embodiment, the UE 200 first applies underlay URSP rules, e.g. the underlay URSP rule 400. These rules instruct the UE 200 as to how to route data traffic across the underlay network 120 (i.e., how to select a route in the underlay network 120). For example: a first underlay URSP rule may instruct the UE 200 to send traffic of the application having ID “com.example.app3” via the underlay PDU session 125 established over non-3GPP access and using parameter DNN-b; a second underlay URSP rule may instruct the UE 200 to send traffic of an application having ID “com.example.app2” directly to a non-3GPP access network, outside of an underlay PDU session (this is also known as “non-seamless offload”); and a third underlay URSP rule may instruct the CE 200 to send traffic of an application having ID “com.example.app1” to the overlay network 122 via the underlay PDU session 125 established over 3GPP access and using parameters DNN-a, S-NSSAI-b. 1971 in this embodiment, the UE 200 next applies overlay URSP rules to select a route for the traffic to be sent to the overlay network 122, as indicated by the underlay URSP rule 400.

More specifically, referring to FIG. 7, having first applied the underlay URSP rule 400, which indicates that the traffic of the application having ID “com.example.app1” (according to the first TD 500) is to be sent to the overlay network 122 via the underlay PDU session 125 established over 3GPP access and using the parameters DNN-a and S. NSSIA-b, the UE 200 then applies the overlay URSP rule 401 to select a route for this traffic. The overlay URSP rule 401 shown in FIG. 7 (from the first HtNW 110) indicates that the traffic of the application having ID “com.example.app1” should be sent via an overlay PDU session using the parameters DNN-x and S-NSSAI-y. Tis triggers the UE 200 to establish this overlay PDU session 402 first (if it does nor exist already) via the corresponding underlay PDU session (e.g. the underlay PDU session 125), and then to send the traffic of the application having ID “com.example.app1” via this overlay PDU session 402.

In this embodiment, the procedure applied by the UE 200 may be summarized as follows.

The CE 200 determines, from the underlay URSP rule 400, the traffic to sent to the overlay network 122 and, for this traffic, applies the overlay URSP rule 401 to select a route (e.g., the overlay PDU session 402). For all other traffic, i.e., for the traffic not to be sent to the overlay network 122, the UE 200) applies the underlay URSP rule 400 to select a route.

The result of the above procedure is shown in FIG. 7, which is a schematic illustration of the network architecture 100 in which the U. 200 may access the overlay network 122 via the underlay network 120.

In this embodiment, the UE 200 sends the traffic of the application having ID “com.example.app1” via the overlay PDU session 402 (as determined by the overlay URSP rule 401), which is established via the underlay PDU session 125 (as determined by the underlay URSP rule 400). Thus, the UE 200 may access a suitable service. i.e. the third service 109, through the overlay PDU session 402 in the overlay network 122 via the underlay PDU session 125 in the underlay network 120.

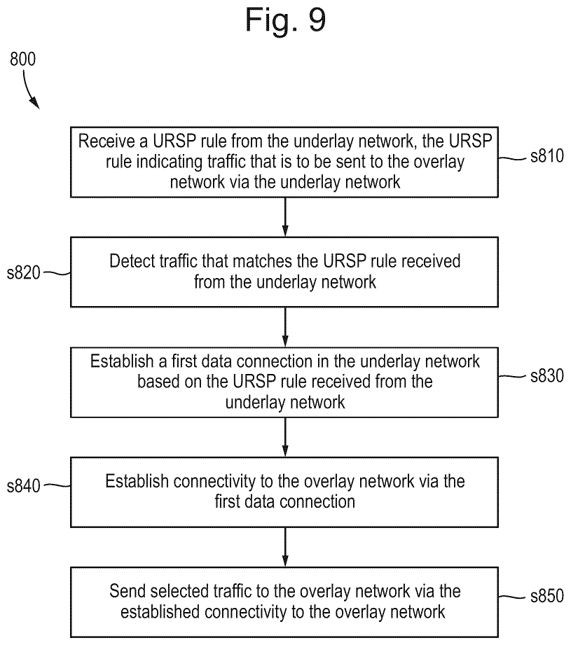

FIG. 9 is a process flow chart showing certain steps of a method 800 which may be performed by the UE 200. The method 800 may be used to trigger the UE 200 to establish connectivity to the overlay network 122 and send traffic thereto, e.g. to allow the UE 200 to use one or more services.

In this embodiment, the underlay network 120 is an underlay mobile network. In this embodiment, the overlay network 122 is an overlay mobile network.

The method 800 comprises, at step s810, receiving a URSP rule from the underlay network 120. Specifically, in this embodiment, the URSP rule received from the underlay network 120 is the underlay URSP rule 400. However, in other embodiments, the URSP rule received from the underlay network 120 is another URSP rule other than the underlay URSP rule 400.

In this embodiment, the underlay URSP rule 40W indicates traffic that is to be sent to the overlay network 122 via the underlay network 120. Specifically, in this embodiment, the traffic to be sent to the overlay network 122 via the underlay network 120 is the traffic of the application having ID “com.example.app1” as indicated in the first TD 500 in FIG. 7. However, in other embodiments, the traffic to be sent to the overlay network 122 via the underlay network 120 is traffic other than the traffic of the application having ID “com.example.app1”.

At step s820, the UE 200 detects traffic that matches the URSP rule received from the underlay network 120, i.e. that matches the underlay URSP rule 4001.

At step s830, the UE 200 establishes a first data connection in the underlay network 120 based on the URSP rule received from the underlay network 120, i.e., based on the underlay URSP rule 400. Specifically, in this embodiment, the first data connection is the underlay PDU session 125 as indicated in FIG. 7. However, in other embodiments, the first data connection is another data connection. e.g. a PDU session, between the UE 200 and the underlay network 120.

Step s830 may be carried out by the UE 200 in accordance with an RSD of the URSP rule received from the underlay network 120. i.e. in accordance with the first RSD 502 of the underlay URSP rule 400.

At step s840, the UE 200 establishes connectivity, i.e. establishes a connection, to the overlay network 122 via the first data connection. i.e. via the underlay PDU session 125.

At step s850, the UE 200 sends selected traffic to the overlay network 122 via the connectivity (i.e. the established connection) to the overlay network 122 established at step s840. In this embodiment, the selected traffic is traffic that matches the URSP rule received from the underlay network 120. i.e. that marches the underlay URSP rule 400.

Step s850 may be carried out by the UE 210 in accordance with an RSD of the URSP rule received from the underlay network 120, i.e. in accordance with the first RSD 502 of the underlay URSP rule 4R).

Thus, a method 800, performed by the UE 200, of triggering die UE 200 to establish connectivity to the overlay network 122 and send traffic thereto is provided.

In an embodiment, the transceiver 225 of the UE 200 is arranged to communicate with the underlay network 120.

In this embodiment, the processor 205 of the UE 200 is arranged to receive a URSP rule from the underlay network 120, i.e. to receive the underlay URSP rule 400. The underlay URSP rule 400 indicates traffic that is to be sent to the overlay network 122 via the underlay network 120. Specifically, in this embodiment, the traffic to be sent to the overlay network 122 via the underlay network 120 is the traffic of the application having ID “com.example.app1” as indicated in the first TD 500 in FIG. 7. However, in other embodiments, the traffic to be sent to the overlay network 122 via the underlay network 120 is traffic other than the traffic of the application having ID “com.example.app1”. The processor 205 of the UE 200 is thus arranged to carry out step s810 of the method 800.

In this embodiment, the processor 205 of the UE 200 is further arranged to detect traffic that marches the URSP rule received from the underlay network 120, i.e. that matches the underlay URSP rule 400. The processor 205 of the UE 200 is thus arranged to carry out step s820 of the method 800.

In this embodiment, the processor 205 of the UE 200 is further arranged to establish, using the transceiver 225, a first data connection in the underlay network 120 based on the URSP rule received from the underlay network 120, i.e. based on the underlay URSP rule 400. Specifically, in this embodiment, the first data connection is the underlay PDU session 125 as indicated in FIG. 8. However, in other embodiments, the first data connection is another data connection, e.g. a PDU session, between the U. 200 and the underlay network 120.

In this embodiment, the processor 205 of the UE 201 may be arranged to establish, using the transceiver 225, the first data connection in accordance with an RSD of the URSP rule received from the underlay network 120, i.e. in accordance with the first RSD 502 of the underlay URSP rule 400. The processor 205 of the UE 200 is thus arranged to carry out step s830 of the method 8).

In this embodiment, the processor 205 of the UE 200 is further arranged to establish, using the transceiver 225, connectivity to the overlay network 122 via the first data connection, i.e. via the underlay PDU session 125. The processor 205 of the UI 200 is thus arranged to carry out step s840 of the method 80X).

In this embodiment, the processor 205 of the UE 200 is further arranged to send, using the transceiver 225, selected traffic to the overlay network 122 via die connectivity to the overlay network 122 established at step s840. In this embodiment, the selected traffic is traffic that marches the URSP rule received from the underlay network 120, i.e. that matches the underlay URSP rule 400.

In this embodiment, the processor 205 of the UE 2100 may be arranged to establish, using the transceiver 225, the first data connection in accordance with an RSD of the URSP rule received from the underlay network 120, i.e. in accordance with the first RSD 502 of the underlay URSP rule 400. The processor 205 of the UE 20) is thus arranged to carry out step s850 of the method 800.

In this embodiment, the underlay network 120 may be an underlay mobile network, and the overlay network 122 may be an overlay mobile network, and the first data connection may be at underlay data connection.

In this embodiment, die URSP rule received from the underlay network 120, i.e. the underlay URSP rule 400, may identify an application of which traffic is to be sent to the overlay network 122.

In this embodiment, the URSP rule received from the underlay network 120. i.e. the underlay URSP rule 400, may comprise an overlay network component, the overlay network component comprising an identity of the overlay network 122, and the URSP rule may indicate that the traffic marching the URSP rule should be sent to the overlay network 122 via the first data connection, i.e. the underlay PDU session 125.

In this embodiment, the first data connection may be a PDU session (e.g. other than the underlay PDU session 125) and the URSP rule may specify parameters for the PDU session via which the connectivity to the overlay network 122 is to be established.

In this embodiment, die processor 205 may be arranged to establish the connectivity to the overlay network 122 by discovering a N3IWF in the overlay network 122, e.g. the N3IWF 126. The processor 205 may be further arranged to establish the connectivity to the overlay network 122 by performing a registration procedure with the overlay network 122 via the discovered N3IWF, thereby to register the UE 200 with the overlay network 122.

In this embodiment, the processor 205 of the UE 210 may be arranged to perform the registration procedure, including sending, using the transceiver 225, to the overlay network 122, authentication credentials for the overlay network 122.

Alternatively, in this embodiment, the processor 205 may be arranged to perform the registration procedure, including sending, using the transceiver 225, to the overlay network 122, authentication credentials for the underlay network 120. e.g. the HPLMN credentials as currently defined in 3GPP specifications.

In this embodiment, the processor 205 of the UE 200 may be further arranged to receive a further URSP rule from the overlay network 122. In this embodiment, the further URSP rule is the second URSP rule 401. However, in other embodiments, the further URSP rule may be a URSP rule other than the second URSP rule 401. The processor 205 may be further arranged to perform a conflict avoidance procedure to avoid conflict between the URSP rule and the further URSP rule, i.e. between the first and second URSP rules 400, 401.

In this embodiment, the further URSP may indicate a second data connection in the overlay network 122 via which traffic matching the further URSP rule is to be sent. Specifically, in this embodiment, the second data connection is the overlay PDU session 402 as indicated in FIG. 8. However, in other embodiments, the second data connection may be a data connection, e.g. a PDU session, in the overlay network 122 other than the overlay PDU session 402, having parameters such as DNN, S-NSSAI, etc.

In this embodiment, the processor 205 of the UE 200 may be arranged to perform the conflict avoidance procedure including applying the URSP, i.e. the underlay URSP rule 400, to determine the traffic that is to be sent to the overlay network 122 via the first data connection, i.e. the underlay PDU session 125. The processor 205 may be further arranged to perform the conflict avoidance procedure including applying the further URSP rule, i.e. the overlay URSP rule 401, to select the second data connection, i.e. the overlay PDU session 402, in the overlay network 122 for the determined traffic. In other words, in embodiments in which the processor 205 is so-arranged, the processor 205 applies only the underlay URSP rule 401 to traffic which is not to be sent to the overlay network 122.

In this embodiment, the processor 205 of the UE 200 may be arranged to establish the connectivity to the overlay network 122 via the first data connection, i.e. via the underlay PDU session 125, in response to the detecting traffic that matches the URSP rule, i.e. the underlay URSP rule 400.

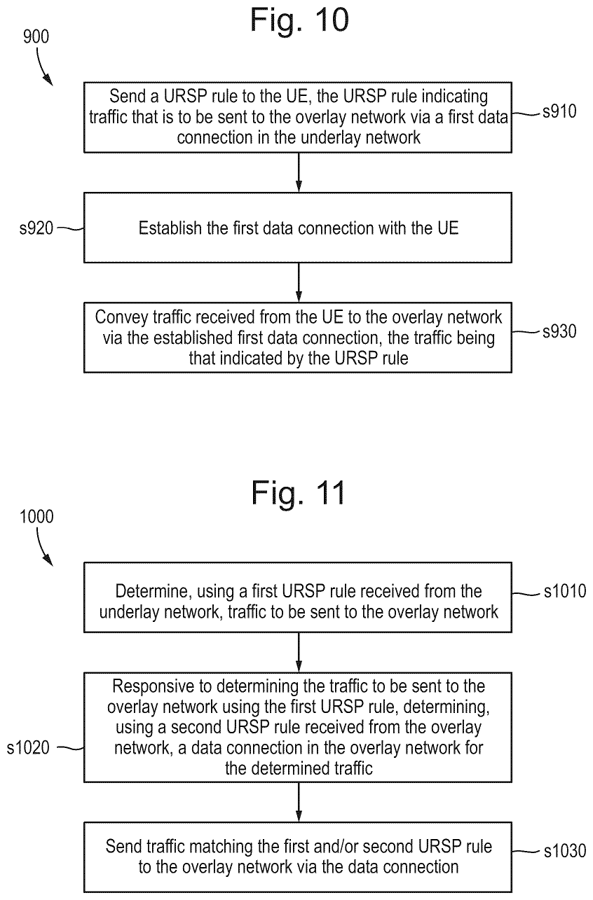

FIG. 10 is a process flow chart showing certain steps of a method 900 performed by one or more network nodes, e.g. the node 300, of the underlay network 120 used by the UI 200.

In this embodiment, the underlay network 120 is an underlay mobile network. In this embodiment, the overlay network 122 is an overlay mobile network.

At step s910, the one or more network nodes sends a URSP rule to the UE 200. The URSP rule indicates traffic that is to be sent to the overlay network 122 via a first data connection in the underlay network 120. Specifically, in this embodiment, the first data connection is the underlay PDU session 125 as indicated in FIG. 8. However, in other embodiments, the first data connection may be a data connection, e.g. a PDU session, in the underlay network 122 other than the underlay PDU session 125.

At step s920, the one or more network nodes establishes the first data connection with the UE 200.

At step s930, the one or more network nodes conveys traffic received from the UE 200 to the overlay network 122 via the established first data connection, i.e. via the underlay PDU session 125, the traffic being that indicated by the URSP rule, i.e. by the underlay URSP rule 400.

Thus, a method 900, performed by one or more network nodes, e.g. the node 300, of triggering the UE 200 to establish connectivity to the overlay network 122 and send traffic thereto is provided.

In an embodiment, one or more network nodes, e.g. the node 300, of the underlay network 120 used by the UE 200 is arranged to send a URSP rule which indicates traffic that is to be sent to the overlay network 122 via a first data connection in the underlay network 120. Specifically, in this embodiment, the URSP rule is the underlay URSP rule 400, although in other embodiments the URSP rule may be a URSP ride other than the underlay URSP rule 400. Specifically, in this embodiment, the first data connection is the underlay PDU session 125 as indicated in FIG. 8. However, in other embodiments, the first data connection may be a data connection, e.g. a PDU session, in the underlay network 122 other than the underlay PDU session 125.

In this embodiment, the one or more network nodes is further arranged to establish the first data connection with the UE 200.

In this embodiment, the one or more network nodes is further arranged to convey traffic received from the UE 200 to the overlay network 122 via the established first data connection, i.e. via the underlay PDU session 125, the traffic being that indicated by the URSP rule, i.e. by the underlay URSP rule 400.

FIG. 11 is a process flow chart showing certain steps of a method 100 which may be performed by the UE 200. The method 1000) may be used by the UE 200 to perform conflict avoidance, i.e. to avoid conflict between an underlay URSP rule and an overlay URSP rule, e.g. to allow the UE 200 to use one or more services.

Method 1000 includes, at step s1010, determining, using a first URSP rule received from the underlay network 120, traffic to be sent to the overlay network 122. Specifically, in this embodiment, the first URSP rule is the underlay URSP rule 400. However, in other embodiments, the first URSP rule may be a URSP rule received from the underlay network 120 other than the underlay URSP rule 400.

In this embodiment, the underlay network 120 is an underlay mobile network, and the overlay network 122 is an overlay mobile network.

At step s020, the UE 200, responsive to determining the traffic to be sent to the overlay network 122 using the first URSP rule, i.e. the underlay URSP rule 400, determining, using a second URSP rule received from the overlay network 122, a data connection in the overlay network 122 for the determined traffic. Specifically, in this embodiment, the second URSP rule is the overlay URSP rule 401. However, in other embodiments, the second URSP rule may be a URSP rule received from the overlay network 122 other than the overlay URSP rule 400. Specifically, in this embodiment, the data connection in the overlay network 122 is the overlay PDU session 402 as indicated in FIG. 8. However, in other embodiments, the data connection may be a data connection, e.g. a PDU session, in the overlay network 122 other than the overlay PDU session 402.

At step s1030, the UE 200 sends traffic matching the first and/or second URSP rule, i.e. the underlay and/or overlay URSP rule 400/401, to the overlay network 122, via the data connection, i.e. via the overlay PDU session 402.

Thus, a method 1000, performed by the UE 200, of conflict avoidance, i.e. to avoid conflict between an underlay URSP rule and an overlay URSP rule, is provided.

In an embodiment, the transceiver 225 of the UE 200 is arranged to communicate with the underlay network 120 and with the overlay network 122 via the underlay network 120.

In this embodiment, the processor 205 of the UE 200 is arranged to determine, using a first URSP rule received from the underlay network 120, traffic to be sent to the overlay network 122. Specifically, in this embodiment, the first URSP rule received from the underlay network 120 is the underlay URSP rule 400. However, in other embodiments, the first URSP rule received from the underlay network 120 is another URSP rule other than the underlay URSP rule 400. The processor 205 of the UE 2101 is thus arranged to carry our step s1010 of the method 1000.

In this embodiment, the processor 205 of the UE 200 may be further arranged to, responsive to determining the traffic to be sent to the overlay network 122 using the first URSP rule, i.e. the underlay URSP rule 400, determine, using a second URSP rule received from the overlay network 122, a data connection in the overlay network 122 for the determined traffic. Specifically, in this embodiment, the second URSP rule is the overlay URSP rule 401. However, in other embodiments, the second URSP rule may be a URSP rule received from the overlay network 122 other than the overlay URSP rule 400. Specifically, in this embodiment, the data connection in the overlay network 122 is the overlay PDU session 402 as indicated in FIG. 8. However, in other embodiments, the data connection may be a data connection, e.g. a PDU session, in the overlay network 122 other than the overlay PDU session 402. The processor 205 of the UE 200 is thus arranged to carry out step s1020 of the method 1000.

In this embodiment, the processor 205 of the UE 200 is further arranged to send traffic matching the first and/or second URSP rule, i.e. the underlay and/or overlay URSP rule 400/401, to the overlay network 122, via the data connection, i.e. via the overlay PDU session 402. The processor 205 of the UE 200 is thus arranged to carry out step s1030 of the method 1000.

In this embodiment, the processor 205 of the UE 200 may be further arranged to determine, using the first URSP rule, i.e. die underlay URSP rule 400, a further data connection in the underlay network 120, via which the data connection is to be established. The further data connection may be, e.g., a PDU session in the underlay network 120. The determined traffic to be sent to the overlay network 122 may be sent via the further data connection in the underlay network 120.

In this embodiment, the underlay network 120 may be an underlay mobile network, and the overlay network 122 may be an overlay mobile network, the data connection may be an overlay data connection, and the further data connection may be an underlay data connection.

In this embodiment, the processor 205 of the UE 200 may be farther arranged to receive the first URSP rule, i.e. the underlay URSP rule 400, from the underlay network 120.

In this embodiment, the processor 205 of the UE 200 may be further arranged to receive the second URSP rule, i.e. the overlay URSP rude 401, from the overlay network 122.

In this embodiment, the processor 205 of the UE. 200 may be further arranged to receive the second URSP rule, i.e. the overlay URSP rule 401, from the overlay network 122 via the underlay network 120.

In this embodiment, the first URSP rule, i.e. the underlay URSP rule 400, may indicate die traffic that is to be sent to the overlay network 122 via the further data connection in the underlay network 120.

In this embodiment, the processor 205 of the UE 200 may be arranged to detect traffic that matches the first URSP rule, i.e. die underlay URSP rule 400. The processor 205 of the UE 200 may be further arranged to, responsive to detecting traffic that matches the first URSP rule, i.e. the underlay URSP rule 4001, establish, using the transceiver 225, further data connection in the underlay network 120, wherein the further data connection sends the detected traffic to the overlay network 122.

In this embodiment, the further data connection is a data connection in the underlay network 120. The further data connection may be a PDU session in the underlay network 122, e.g. the underlay PDU session 125.

In this embodiment, the data connection is a data connection in the overlay network 122. The data connection may be a PDU session in the overlay network 122, e.g. the overlay PDU session 402.

In this embodiment, the first URSP rule, i.e. the underlay URSP rule 400, and/or the second URSP rude i.e. the overlay URSP ride 401, may identify an application of which traffic is to be sent to the overlay network 122.

In this embodiment, die first URSP rule, i.e. the underlay URSP rule 400, may comprise an overlay network component, the overlay network component comprising the identity of the second mobile network, wherein the first URSP rule indicates that traffic marching the first URSP rule should be sent to the overlay network 122.

In this embodiment, the first URSP rule, i.e. the underlay URSP rule 400, may specify parameters for a PDU session, e.g. the underlay PDU session 125, in the underlay network 120 via which the connectivity to the overlay network 122 is to be established.

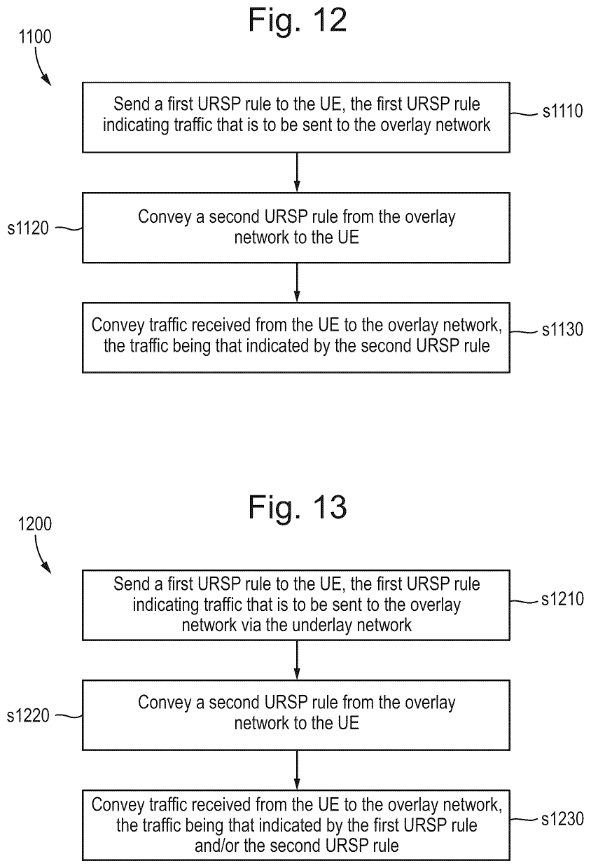

FIG. 12 is a process low chart showing certain steps of a method 1100 performed by one or more network nodes, e.g. the node 300, of the underlay network 120 used by the UE 200.

In this embodiment, the underlay network 120 is an underlay mobile network. In this embodiment, the overlay network 122 is an overlay mobile network.

At step s1110 the one or more network nodes sends a first URSP rude to the UE 200. The first URSP rule indicates traffic that is to be sent to the overlay network 122. Specifically, in this embodiment, the first URSP rule is the underlay URSP rule 400. However, in other embodiments, the first URSP rule may be a URSP rule other than the underlay URSP rule 400.

At step s1120, the one or more network nodes conveys a second URSP rule from the overlay network 122 to the UE 200. Specifically, in this embodiment, the second URSP rule is the overlay URSP rue 401. However, in other embodiments, the second URSP rule may be a URSP rule other than the overlay URSP rule 401.

At step s1130, the one or more network nodes conveys traffic received from the UE 200 to the overlay network 122, the traffic being that indicated by the second URSP rule, i.e. by the overlay URSP rule 401.

Thus, a method 11K), performed by one or more network nodes, e.g. the node 300, of the underlay network 120 used by the UE 200 of facilitating conflict avoidance in the UE 200 is provided.

FIG. 13 is a process flow chart showing certain steps of a method 1200 performed by one or more network nodes, e.g. the node 300, of the underlay network 120 used by the UE 200.

In this embodiment, the underlay network 120 is an underlay mobile network. In this embodiment, the overlay network 122 is an overlay mobile network.

At step s1210, the one or more network nodes sends a first URSP rule to the UE 200. The first URSP rule indicates traffic that is to be sent to the overlay network 122 via the underlay network 120. Specifically, in this embodiment, the first URSP rule is the underlay URSP rule 400. However, in other embodiments, the first URSP rule may be a URSP rule other than the underlay URSP rule 400.

At step s1220, the one or more network nodes conveys a second URSP rule from the overlay network 122 to the UE 200. Specifically, in this embodiment, the second URSP rule is the overlay URSP rule 401. However, in other embodiments, the second URSP rule may be a URSP rule other than the overlay URSP rule 401.

At step s1230, the one or more network nodes conveys traffic received from the UE 200 to the overlay network 122, the traffic being that indicated by the first URSP rule, i.e. by the underlay URSP rule 400, and/or that indicated by the second URSP rule, i.e. by the overlay URSP rule 401.

Thus, a further method 1100, performed by one or more network nodes, e.g. the node 300, of the underlay network 120 used by the UE 200 of facilitating conflict avoidance in the UE 200 is provided.

The embodiments described above provide functionality not currently not supported in 3GPP networks.

In particular, the above embodiments provide a method for an underlay network to trigger a UE to establish connectivity to an overlay network while the UE remains connected with the underlay network, and a method for selecting the traffic to be sent to the overlay network. Advantageously, this tends to improve speed and convenience of access to services to which an overlay network subscribes.

Advantageously, after the UE connects simultaneously with the underlay and the overlay networks, it defines how the UE applies the URSP rules provided to UE by both of the underlay and overlay networks, in a way that tends to avoid conflicts and fulfil the route selection requirements of both networks.

It should be noted that the above-mentioned methods and apparatuses illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed methods and apparatuses may be applied. For example, while specific examples have been given in the contest of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry our the hereinbefore described methods.

The described methods and apparatuses may be practiced in other specific forms. The described methods and apparatuses are to be considered in all respects only as illustrative and nor restrictive. The scope of the invention is, therefore, indicated by the appended claims rather than by the foregoing description. All changes which come within the meaning and range of equivalency of the claims are to be embraced within their scope.

1. A user equipment (UE) for wireless communication, comprising:
at least one memory;
at least one processor coupled with the at least one memory and configured to cause the UE to:
receive a UE Route Selection Policy (URSP) rule from a first mobile network, wherein the URSP rule indicates traffic that is to be sent to a second mobile network via the first mobile network;
detect traffic that matches the URSP rule;
establish a first data connection in the first mobile network based on the URSP rule;
establish connectivity to the second mobile network via the first data connection; and
send selected traffic to the second mobile network via the established connectivity to the second mobile network, the selected traffic being the traffic that matches the URSP rule.

2. The UE of claim 1, wherein the first mobile network is an underlay mobile network, the second mobile network is an overlay mobile network, and the first data connection is an underlay data connection.

3. The UE of claim 1, wherein the URSP rule identifies an application of which traffic is to be sent to the second mobile network.

4. The UE of claim 1, wherein the URSP rule comprises an overlay network component, the overlay network component comprising an identity of the second mobile network, and wherein the URSP rule indicates that the traffic matching the URSP rule should be sent to the second mobile network via the first data connection.

5. The UE of claim 1, wherein the first data connection is a Protocol Data Unit (PDU) session and wherein the URSP rule specifies parameters for the PDU session via which the connectivity to the second mobile network is to be established.

6. The UE of claim 1, wherein the at least one processor is configured to cause the UE to: establish the first data connection using parameters in a Route Selection Descriptor (RSD) of the URSP rule.

7. The UE of claim 1, wherein the at least one processor is configured to cause the UE to: establish the connectivity to the second mobile network by:
discovering a Non-3GPP Interworking Function (N3IWF) in the second mobile network; and
performing a registration procedure with the second mobile network via the discovered N3IWF to register the UE apparatus with the second mobile network.

8. The UE of claim 7, wherein the at least one processor is configured to cause the UE to; perform the registration procedure by sending, to the second mobile network, authentication credentials for the second mobile network.

9. The UE of claim 7, wherein the at least one processor is configured to cause the UE to; perform the registration procedure by sending to the second mobile network, authentication credentials for the first mobile network.

10. The UE apparatus of claim 1, wherein the at least one processor is further configured to cause the UE to:
receive a further URSP rule from the second mobile network; and
perform a conflict avoidance procedure to avoid conflict between the URSP rule and the further URSP rule.

11. The UE of claim 10, wherein the further URSP rule indicates a second data connection in the second mobile network via which traffic matching the further URSP rule is to be sent.

12. The UE of claim 10, wherein the at least one processor is configured to cause the UE to: perform the conflict avoidance procedure by:
applying the URSP rule to determine the traffic that is to be sent to the second mobile network via the first data connection; and
applying the further URSP rule to select a second data connection in the second mobile network for the determined traffic.

13. The UE of claim 9, wherein the at least one processor is configured to cause the UE to: establish the connectivity to the second mobile network via the first data connection in response to detecting the traffic that matches the URSP rule.

14. A method performed by a user equipment (UE), the method comprising:
receiving a UE Route Selection Policy (URSP) rule from a first mobile network, wherein the URSP rule indicates traffic that is to be sent to a second mobile network via the first mobile network;
detecting traffic that matches the URSP rule;
establishing a first data connection in the first mobile network based on the URSP rule;
establishing connectivity to the second mobile network via the first data connection; and
sending selected traffic to the second mobile network via the established connectivity to the second mobile network, the selected traffic being the traffic that matches the URSP rule.

15. A network entity, comprising:
at least one memory; and
at least one processor coupled with the at least one memory and configured to cause the network entity to:
send a UE Route Selection Policy (URSP) to a user equipment (UE), wherein the URSP rule indicates traffic that is to be sent to a second mobile network via a first data connection in a first mobile network;
establish the first data connection with the UE; and
convey traffic received from the UE to the second mobile network via the established first data connection, wherein the traffic is indicated by the URSP rule.

16. (canceled)

17. A processor for wireless communication, comprising:
at least one controller coupled with at least one memory and configured to cause the processor to:
receive a UE Route Selection Policy (URSP) rule from a first mobile network, wherein the URSP rule indicates traffic that is to be sent to a second mobile network via the first mobile network;
detect traffic that matches the URSP rule;
establish a first data connection in the first mobile network based on the URSP rule;
establish connectivity to the second mobile network via the first data connection; and
send selected traffic to the second mobile network via the established connectivity to the second mobile network, the selected traffic being the traffic that matches the URSP rule.

18. The processor of claim 17, wherein the first mobile network is an underlay mobile network, the second mobile network is an overlay mobile network, and the first data connection is an underlay data connection.

19. The processor of claim 17, wherein the URSP rule identifies an application of which traffic is to be sent to the second mobile network.

20. The processor of claim 17, wherein the URSP rule comprises an overlay network component, the overlay network component comprising an identity of the second mobile network, and wherein the URSP rule indicates that the traffic matching the URSP rule should be sent to the second mobile network via the first data connection.

21. The processor of claim 17, wherein the first data connection is a Protocol Data Unit (PDU) session and wherein the URSP rule specifies parameters for the PDU session via which the connectivity to the second mobile network is to be established.
